(19) United States
(12) Patent Application Publication
(10) Pub. No.: US 2017/0161546 A1
(43) Pub. Date: Jun. 8, 2017

(54) Method and System for Detecting and Tracking Objects and SLAM with Hierarchical Feature Grouping

(71) Applicant: Mitsubishi Electric Research Laboratories, Inc., Cambridge, MA (US)

(72) Inventors: Esra Cansizoglu, Malden, MA (US); Yuichi Taguchi, Arlington, MA (US)

(21) Appl. No.: 14/962,239

(22) Filed: Dec. 8, 2015

(51) Int. Cl. G06K 9/00; G06K 9/32; G06T 7/00; H04N 13/02

(52) U.S. Cl. CPC G06K 9/00201; H04N 13/0203; G06K 9/3233; G06T 7/0042; H04N 2013/0074

(57) ABSTRACT

A method and system detects and localizes an object by first acquiring a frame of a three-dimensional (3D) scene with a sensor, and extracting features from the frame. The frame are segmented into segments, wherein each segment includes one or more features, and for each segment, searching an object map for a similar segment, and only if there is a similar segment in the object map, registering the segment in the frame with the similar segment to obtain a predicted pose of the object. The predicted poses are combined to obtain the pose of the object, which can be outputted.

This U.S. Non-Provisional Application is related to U.S. Non-Provisional application Ser. No. ______ (MERL-2882) co-filed herein with and incorporated herein by reference. That Application discloses a system and method for hybrid simultaneous localization and mapping of 2D and 3D data in images acquired by a red, green, blue, and depth sensor of a 3D scene.

### FIELD OF THE INVENTION

This invention relates generally to computer vision and image processing, and more particularly to detecting and tracking objects using images acquired by a red, green, blue, and depth (RGB-D) sensor and processed by simultaneous localization and mapping (SLAM).

### BACKGROUND OF THE INVENTION

Object detecting, tracking, and pose estimation can be used in augmented reality, proximity sensing, robotics, and computer vision applications using 3D or RGB-D data acquired by, for example, an RGB-D sensor such as Kinect®. Similar to 2D feature descriptors used for 2D-image-based object detection, 3D feature descriptors that represent the local geometry can be defined for keypoints in 3D point clouds. Simpler 3D features, such as point pair features, can also be used in voting-based frameworks. Those 3D-feature-based approaches work well for objects with rich structure variations, but are not suitable for detecting objects with simple 3D shapes such as boxes.

To handle simple as well as complex 3D shapes, RGB-D data have been exploited. Hinterstoisser et al. define multimodal templates for the detection of objects, while Drost et al. define multimodal pair features for the detection and pose estimation, see Hinterstoisser et al., “Multimodal templates for real-time detection of texture-less objects in heavily cluttered scenes,” Proc. IEEE Int'l Conf. Computer Vision (ICCV), pp. 858-865, November 2011, and Drost et al., “3D object detection and localization using multimodal point pair features,” in Proc. Int'l Conf. 3D Imaging, Modeling, Processing, Visualization and Transmission (3DIMPVT), pp. 9-16, October 2012.

Several systems incorporate object detection and pose estimation into a SLAM framework, see Salas-Moreno et al., “SLAM++: Simultaneous localization and mapping at the level of objects,” in Proc. IEEE Conf. Computer Vision and Pattern Recognition (CVPR), June 2013, and Fioraio et al., “Joint detection, tracking and mapping by semantic bundle adjustment,” in Proc. IEEE Conf. Computer Vision and Pattern Recognition (CVPR), 2013, pp. 1538-1545. Salas-Moreno et al. detect objects from depth maps and incorporate the objects as landmarks in a SLAM map for bundle adjustment. Their method only uses 3D data, and thus requires rich surface variations for objects. Fioraio et al. use a semantic bundle adjustment approach for performing SLAM and object detection simultaneously. Based on a 3D model of the object, they generate a validation graph that contains the object-to-frame and frame-to-frame correspondences among 2D and 3D point features. Their method lacks a suitable framework for object representation, resulting in many outliers after correspondence search. Hence, the detection performance depends on bundle adjustment, which might become slower as the map grows.

### SUMMARY OF THE INVENTION

The embodiments of our invention provide a method and system for detecting and localizing objects using a red, green, blue, and depth (RGB-D) image data acquired by a 3D sensor using hierarchical feature grouping.

The embodiments use a novel compact representation of objects by grouping features hierarchically. Similar to a keyframe being a collection of features, an object is represented as a set of segments, where a segment is a subset of features in a frame. Similar to keyframes, segments are registered with each other in an object map.

The embodiments use the same process for both offline object scanning and online object detection modes. In the offline scanning mode, a known object is scanned using a hand-held RGB-D sensor to construct an object map. In the online detection mode, a set of object maps for different objects are given, and the objects are detected via an appearance-based similarity search between the segments in the current image and in the object maps.

If a similar segment is found, the object is detected and localized. In subsequent frames, the tracking is done by predicting the poses of the objects. We also incorporate constraints obtained from the object detection and localization into the bundle adjustment to improve the object pose estimation accuracy as well as the SLAM reconstruction accuracy. The method can be used in a robotic application. For example, the pose is used to pick up an object. Results show that the system is able to detect and pick up objects successfully from different viewpoints and distances.

### BRIEF DESCRIPTION OF THE DRAWINGS

FIG. 1 is a schematic of hierarchical feature grouping using object and SLAM maps according to embodiments of the invention;

FIG. 2 is a schematic of a method and system for object detection and localization according to embodiments of the invention; and

FIG. 3 is a schematic of a SLAM system and method according to embodiments of the invention.

### DETAILED DESCRIPTION OF THE PREFERRED EMBODIMENTS

Object Detection and Localization

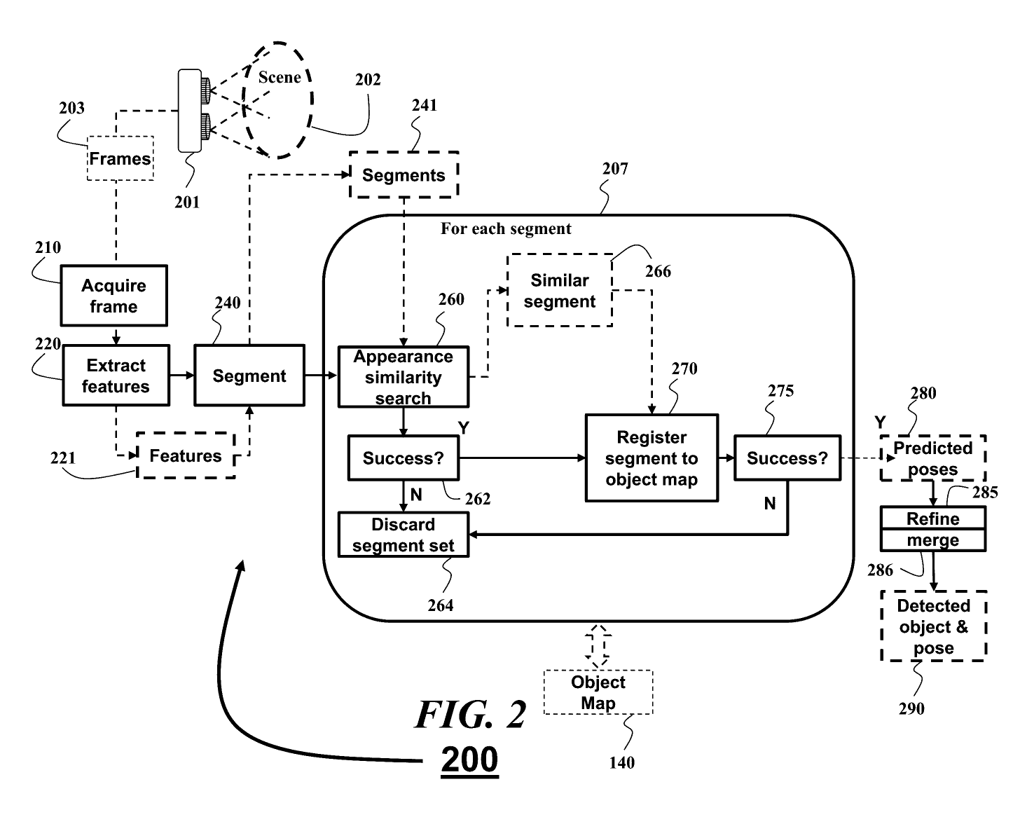

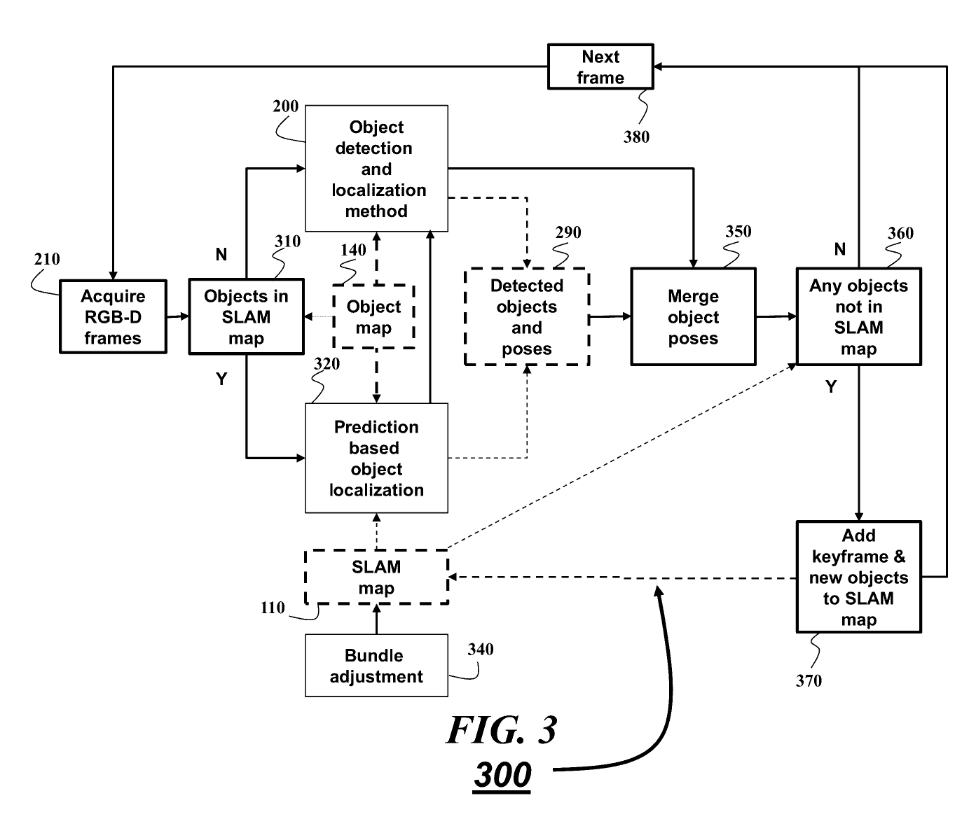

As shown in FIG. 2, the embodiments of our invention provide a method and system 200 for detecting and localizing objects in frames (images) 203 acquired of a scene 202 by, for example, a red, green, blue, and depth (RGB-D) sensor 201. The method can be used in a simultaneous localization and mapping (SLAM) system and method 300 as shown in FIG. 3. In the figures generally, solid lines indicate processes and process flow, and dashed lines indicate data and data flow. The embodiments use segment sets 241 and represent an object in an object map 140 including a set of registered segment sets.

Both an offline scanning and online detection modes are described in a single framework by exploiting the same SLAM method, which enables instant incorporation of a given object into the system. The invention can be applied to a robotic object picking application.

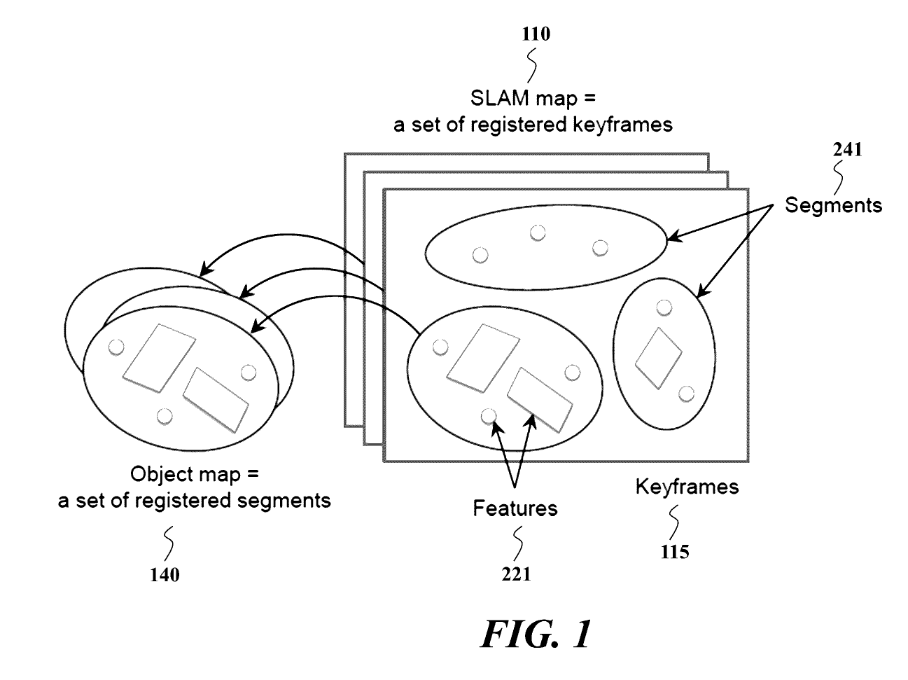

FIG. 1 shows our hierarchical feature grouping. A SLAM map 110 stores a set of registered keyframes 115, each associated with a set of features 221. We use another hierarchy based on segments 241 to represent an object. A segment contains a subset of features 221 in a keyframe, and an object map 140 includes a set of registered segments. The object map is used for the object detection and pose estimation as described below. In our system, the segments can be generated by depth-based segmentation.

One contribution of the invention is representing objects based on the hierarchical feature grouping as shown in FIG. 1. Just as a keyframe is a collection of features, a subset of features in a frame or image defines a segment. A keyframe-based SLAM system constructs the SLAM map 110 containing keyframes registered with each other. Similarly, we group a set of segments registered with each other to generate the object map 140 corresponding to the object. Because an instance of an object in a frame can contain multiple segments, the object map can contain multiple segments from a single frame. The object map provides a compact representation of the object observed under different viewpoint and illumination conditions.

Our system exploits the same SLAM method to handle offline object scanning and online object detection modes. Both modes are essential to achieve an object detection and localization that can incorporate a given object instantly into the system. The goal of the offline object scanning is to generate the object map 140 by considering appearance and geometry information of known objects. We perform this process with user interaction. The system displays candidate segments that might correspond to the object to the user. Then, the user selects the segments corresponding to the object in each keyframe that is registered with the SLAM system.

During online object detection, the system takes a set of object maps corresponding to different objects as the input, and then localizes these object maps with respect to the SLAM map that is generated during the online SLAM session.

Our system first generates 240 sets of one or more segments 241 from each frame 203 using the depth-based segmentation procedure based on the features. For example, if the object is a box, for a particular view, the features described as be planes, edges and corners, which essentially are associated descriptors of the features.

An appearance similarity search 260, using vector of locally aggregated descriptors (VLAD) and the segment sets, is performed to determine similar sets of segments 266. The searching 260 can use an appearance based similarity search of the object map 140. If 262 the search is unsuccessful, the segment set is discarded 264.

Otherwise, if the search is successful, random sample consensus (RANSAC) registration 270 is performed to localize the segment set in the current frame with the object map. Set of segments with successful 275 RANSAC registration initiate objects in the SLAM map 110 as object landmark candidates. The pose of such objects can then be predicted 280.

The pose of each object landmark candidate is refined 285 by a prediction-based registration, and when it is successful, the candidate becomes an object landmark. The list of object landmarks are merged 286 by identifying the refined poses, i.e., if two object landmarks correspond to the same object map and have similar poses, then the landmarks are merged. The refining and merging steps are optional to achieve more accurate results.

The output includes a detected object and pose 290. The method can be performed in a processor connected to memory, input/output interfaces and the sensor by buses as known in the art.

The method can be repeated for a next frame with the sensor at a different viewpoint and pose.

In subsequent frames, we can use the same prediction-based registration and merging processes to track the object landmarks. Consequently, an object landmark in the SLAM map serves as the representation of the object in the real world. Note that this procedure applies to both the offline object scanning and online object detection modes. In the offline mode, the object map is incrementally constructed using the segment sets specified in the previous keyframes, while in the online mode the object map is fixed.

Object Detection and Localization Via Hierarchical Feature Grouping

Our object detection and tracking framework is based in part on a point-plane SLAM system, see Taguchi et al., “Point-plane SLAM for hand-held 3D sensors,” Proc. IEEE Int'l Conf. Robotics and Automation (ICRA), pp. 5182-5189, May 2013.

That point-plane SLAM system localizes each frame with respect to a SLAM map using both 3D points and 3D planes as primitives. An extended version uses 2D points as primitives and determines 2D-to-3D correspondences as well as 3D-to-3D correspondences to exploit information in regions where the depth is not available, e.g., the scene point is too close or too far from the sensor.

Our segments include 3D points and 3D planes (but not 2D points) as features, while the SLAM procedure exploits all the 2D points, 3D points, and 3D planes as features to handle the case where the camera is too close or too far from the object and depth information is not available.

Only segments that have similarity scores greater than a predetermined threshold are returned to eliminate segments that do not belong to any objects of interest. Then the set of segments in the frame are registered with the similar sets of segments in the object map. During the registration, we perform all-to-all descriptor similarity matching between the point features of the two segment sets followed by the RANSAC-based registration 270 that also considers all possible plane correspondences. The segment set that generates the largest number of inliers is used as the corresponding object. If 275 RANSAC fails for all of the k similar segment sets in the object maps, then the segment set extracted from the frame is discarded 264.

This step produces object landmark candidates. We consider these object landmarks as candidates, because the segments are only registered with a single segment set in the object map, not with the object map as a whole. An object can also correspond to multiple segments in the frame, resulting in repetitions in this list of object landmark candidates. Thus, we proceed with a pose refinement 285 and merging 286.

Prediction-Based Object Registration

We project all point and plane landmarks of the object map to the current frame based on the predicted pose of the object landmark candidate. Matches between point measurements of the current frame and point landmarks of the object map are determined. We ignore unnecessary matches based on two rules:
(i) a point measurement is matched with a point landmark when the projected landmark is within a r pixel neighborhood, for example, r is 10; and
(ii) a point measurement is matched with a point landmark when the landmark is at a similar viewing angle when the object map was constructed.

The first rule avoids unnecessary point pairs that are too far on the object, and the second rule avoids performing matches for point landmarks that are behind the object from the current viewing angle of the frame.

Similarly, a plane measurement is considered a candidate match when it is visible from the viewing angle used for the frame. Note that the object map is matched with the features included in the segments, and with all the features in the frame. Thus, this step does not assume any depth-based segmentation and can work with object landmark candidates initiated using other methods, e.g., 2D-image-based detection methods.

Merging

Because an object in the frame can include multiple segments, the list of object landmarks can include redundancies. Therefore, we merge 286 the object landmarks that have similar poses, belonging to the same object.

SLAM System

FIG. 3 is a schematic of a SLAM system and method 300 according to the embodiments of the invention that uses the object detection and localization as shown in FIG. 2.

As before, frames are acquired 210. In step 310, we determine whether the SLAM map 110 includes any objects. If no, we apply the object detection and localization method 200 to the next frame to produce detected objects and poses 290. If yes, we apply the prediction-based object localization 320, followed by the object detection and localization 200. Step 350 merges object poses.

Step 360 determines if any of the detected objects are not in the SLAM map, i.e., the objects are new. If not, process the next frame 380. Otherwise, add 370 a keyframe and the new object to the SLAM map 110.

SLAM Map Update

In a SLAM system, the frame is added to the SLAM map as a keyframe when the pose is different from the poses of any existing keyframes in the SLAM map. We can also add a frame as a keyframe when the frame includes new object landmarks to initialize the object landmarks and maintain the measurement-landmark associations.

Bundle Adjustment

Bundel adjustment 340 can be applied to the SLAM map. Bundle adjustment refines the 3D coordinates describing the scene and relative motion obtained from images depicting the 3D points from different viewpoints. The refinement incorporates constraints obtained from the object detection and localization.

A triplet (k, l, m) denotes an association between feature landmark pₗ and feature measurement pₘ^{k} of keyframe k with pose Tₖ. Let I contain the triplets representing all such associations generated by the SLAM system in the current SLAM map. A tuple (k, l, m, o) denotes an object association, such that the object landmark o with pose \tilde{T}ₒ contains an association between the feature landmark pₗ^{o} of the object map and feature measurement pₘ^{k} in keyframe k. Iₒ contains the tuples representing such associations between the SLAM map and the object map.

An error E_{kf} that comes from the registration of the keyframes in the SLAM map is

E_{kf}(p₁, . . . , p_{L}; T₁, . . . , T_{K})=Σ_{(k,l,m)∈I} d(pₗ, Tₖ⁻¹(pₘ^{k})), (1)

where d(•,•) denotes the distance between a feature landmark and a feature measurement and T(f) denotes application of transformation T to the feature f.

An error E_{obj} due to object localization is

E_{obj}(T₁, . . . , T_{K}; \tilde{T}₁, . . . , \tilde{T}_{O})=Σ_{(k,l,m,o)∈I}_{ₒ} d(pₗ^{o}, \tilde{T}ₒTₖ⁻¹(pₘ^{k})). (2)

The bundle adjustment minimizes a total error with respect to the landmark parameters, keyframe poses, and object poses:

$${arg min}_{∀ {T}_{k} , {\tilde{T}}_{o} , {p}_{l}} {E}_{kf} ( {p}_{1} , … , {p}_{L} ; {T}_{1} , … , {T}_{K} ) + {E}_{obj} ( {T}_{1} , … , {T}_{K} ; {\tilde{T}}_{1} , … , {\tilde{T}}_{O} ) . \qquad ( 3 )$$

### Effect of the Invention

The embodiments of the invention provide a method and system for detecting and tracking objects that can be used in a SLAM system. The invention provides a novel hierarchical feature grouping that uses segments, and represents an object as an object map including a set of registered segments. Both the offline scanning and online detection modes are described by a single framework exploiting the same SLAM procedure, which enables instant incorporation of a given object into the system. The method can be used in an object picking application. For example, the pose is used to pick up an object.

The representations described herein are compact. Namely, there is an analogy between keyframe-SLAM map and segment-object map pairs, respectively. Both use the same features, i.e., planes, 3D points, and 2D points that are extracted from input RGB-D frames.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for detecting and localizing an object, comprising steps:
acquiring a frame of a three-dimensional (3D) scene with a sensor;
extracting features from the frame;
segmenting the frame into segments, wherein each segment includes one or more features, and for each segment comprising:
searching an object map for a similar segment, and only if there is a similar segment in the object map, registering the segment in the frame with the similar segment to obtain a predicted pose of the object;
combining the predicted poses to obtain the pose of the object; and
outputting the pose, wherein the steps are performed in a processor.

2. The method of claim 1, wherein the combining further comprises:
refining and merging the predicted poses.

3. The method of claim 2, wherein the refining is a prediction-based registration between the features of the frame and the features of the object map.

4. The method of claim 1, wherein the searching uses a vector of locally aggregated descriptors (VLAD).

5. The method of claim 1, wherein the data are acquired with a depth sensor.

6. The method of claim 1, further comprising:
constructing, with user interaction, the object map offline by scanning known objects.

7. The method of claim 1, wherein the segmenting uses depth-based segmentation.

8. The method of claim 1, wherein the features are associated with descriptors.

9. The method of claim 1, wherein the registering uses random sample consensus (RANSAC).

10. The method of claim 1, further comprising
picking up the object with a robot arm according to the pose.

11. The method of claim 1, wherein the searching is an appearance-based similarity search.

12. A simultaneous localization and mapping (SLAM) method, comprising steps:
determining whether a SLAM map includes any objects, and if no, applying the method of claim 1 to obtain poses of any objects in the frame, and if yes, applying prediction-based object localization to the frame to obtain the poses of the objects;
merging, for each object, similar poses; and
determining if any of the objects are not in the SLAM map, and if no, processing a next frame, and otherwise, if yes, adding the frame, the objects, and the poses to the SLAM map.

13. The method of claim 12, further comprising:
performing bundle adjustment on the SLAM map using constraints to globally optimize the SLAM map.

14. The method of claim 12, wherein the features include 3D points, two-dimensional (2D) points, and 3D planes.

15. A system for detecting, and localizing an object, comprising:
a sensor configured to acquire a frame of a three-dimensional (3D) scene; and
a processor, connected to the sensor, configured to extract features from the frame, to segment the frame into segments, wherein each segment includes one or more features, and for each segment, searching an object map for a similar segment, and only if there is a similar segment in the object map, registering the segment in the frame with the similar segment to obtain a predicted pose of the object, to combine the predicted poses to obtain the pose of the object, and to output the pose.
